(19) United States
(12) Patent Application Publication
(10) Pub. No.: US 2026/0017935 A1
(43) Pub. Date: Jan. 15, 2026

(54) EXPLAINABLE AI METRICS FOR IC PACKAGING INSPECTION

(71) Applicant: University of Florida Research Foundation, Incorporated, Gainesville, FL (US)

(72) Inventors: Navid Asadi-Zanjani, Gainesville, FL (US); Nitin Varshney, Gainesville, FL (US); Shajib Ghosh, Gainesville, FL (US); Antika Roy, Gainesville, FL (US); Patrick Craig, Gainesville, FL (US); Md Mahfuz Al Hasan, Gainesville, FL (US)

(21) Appl. No.: 19/263,036

(22) Filed: Jul. 8, 2025

Related U.S. Application Data
(60) Provisional application No. 63/668,839, filed on Jul. 9, 2024.

(51) Int. Cl. G06V 10/776; G06T 5/50; G06T 7/00; G06V 10/70; G06V 10/764; G06V 10/82

(52) U.S. Cl. CPC G06V 10/776; G06T 5/50; G06T 7/0004; G06V 10/764; G06V 10/82; G06V 10/87

(57) ABSTRACT

A method and system are directed to generating, using a plurality of candidate machine learning models, a plurality of prediction outputs based on a testing dataset; determining, using the plurality of prediction outputs, a best-performing machine learning model from the plurality of candidate machine learning models based on one or more evaluation metrics; generating, using the best-performing machine learning model, one or more CAM images for an input image; and generating one or more counterfactual explanations based on the one or more CAM images and a subset of prediction outputs of the plurality of prediction outputs that correspond to the best-performing machine learning model.

### CROSS REFERENCE TO RELATED APPLICATION

This application claims the priority of U.S. Provisional Application No. 63/668,839, entitled “EXPLAINABLE AI METRICS FOR IC PACKAGING INSPECTION,” filed on Jul. 9, 2024, the disclosure of which is hereby incorporated by reference in its entirety.

### BACKGROUND

Inspecting advanced packaging systems for integrated circuits presents difficulties due to the intricacy of contemporary semiconductor packages, which include small dimensions, dense structures, and diverse materials. The intricate nature of such semiconductor packages may require accurate identification of minute attributes or features, such as microbumps and through-silicon vias (TSVs). The usage of explainable artificial intelligence (XAI) algorithms may facilitate the comprehension of anomaly detection by providing clarity in decision-making processes. However, a challenge is presented by the absence of standardized metrics to assess the reliability of XAI algorithms.

### BRIEF SUMMARY

Various embodiments described herein relate to methods, apparatus, systems, computing devices, computing entities, and/or the like for evaluating the reliability of explainable artificial intelligence (XAI) results that explain exceptional cases in the physical examination of integrated (IC) advanced packaging systems.

According to some embodiments, a method comprises generating, using a plurality of candidate machine learning models, a plurality of prediction outputs based on a testing dataset; determining, using the plurality of prediction outputs, a machine learning model from the plurality of candidate machine learning models based on one or more evaluation metrics; generating, using the machine learning model, one or more class activation map (CAM) images for an input image; and generating, one or more counterfactual explanations based on the one or more CAM images and a subset of prediction outputs of the plurality of prediction outputs that correspond to the machine learning model.

In some embodiments, the testing dataset comprises a plurality of printed circuit board x-ray or integrated circuit packaging images. In some embodiments, determining the machine learning model comprises determining an ability of the plurality of candidate machine learning models to generate one or more correct predictions corresponding to one or more circuit components. In some embodiments, the one or more evaluation metrics comprise (i) model performance retention (MPR) that measures a degree to which explainable artificial intelligence (XAI) features retain model performance or (ii) context relevance score (CRS) that measures how image context influences XAI fidelity. In some embodiments, a local interpretable model-agnostic explanations (LIME) evaluation is performed on the plurality of candidate machine learning models to determine one or more LIME-based features that correspond to generating a prediction output associated with a type of printed circuit board (PCB) or an integrated circuit packaging component.

In some embodiments, the method further comprises generating an explanatory dataset based on the testing dataset and the plurality of prediction outputs; generating, using an interpretable model trained with the explanatory dataset, a plurality of test outputs; determining one or more LIME-based features for classifying one or more component types based on the plurality of test outputs; and determining, using the one or more LIME-based features, the one or more evaluation metrics. In some embodiments, CRS is determined based on the one or more LIME-based features. In some embodiments, using the one or more LIME-based features, MPR is determined based on model performance corresponding to a candidate machine learning model of the plurality of candidate machine learning models. In some embodiments, determining the one or more LIME-based features comprises determining the one or more LIME-based features from a plurality of component features. In some embodiments, the plurality of component features comprises one or more of circularity, eccentricity, aspect ratio, gray-level co-occurrence matrix (GLCM) contrast, perimeter, solidity, area, entropy, convexity, Tamura contrast, Tamura directionality, or Tamura coarseness. In some embodiments, a SHapley Additive explanation (SHAP) evaluation is performed with the plurality of candidate machine learning models to provide validation of the LIME evaluation. In some embodiments, generating the one or more CAM images comprises determining Eigen-CAM for one or more target layers; and superimposing the one or more CAM images on the input image. In some embodiments, generating the one or more CAM images further comprises generating one or more heatmaps from different layers of the machine learning model.

According to some embodiments, a system comprises one or more processors and at least one memory storing processor-executable instructions that, when executed by any of the one or more processors, causes the one or more processors to perform operations comprising generating, using a plurality of candidate machine learning models, a plurality of prediction outputs based on a testing dataset; determining, using the plurality of prediction outputs, a machine learning model from the plurality of candidate machine learning models based on one or more evaluation metrics; generating, using the machine learning model, one or more class activation map (CAM) images for an input image; and generating one or more counterfactual explanations based on the one or more CAM images and a subset of prediction outputs of the plurality of prediction outputs that correspond to the machine learning model.

In some embodiments, the one or more evaluation metrics comprise (i) model performance retention (MPR) that measures a degree to which explainable artificial intelligence (XAI) features retain model performance or (ii) context relevance score (CRS) that measures how image context influences XAI fidelity. In some embodiments, the operations further comprise performing a local interpretable model-agnostic explanations (LIME) evaluation on the plurality of candidate machine learning models to determine one or more LIME-based features that correspond to generating a prediction output associated with a type of printed circuit board (PCB) or an integrated circuit packaging component. In some embodiments, the operations further comprise generating an explanatory dataset based on the testing dataset and the plurality of prediction outputs; generating, using an interpretable model trained with the explanatory dataset, a plurality of test outputs; determining one or more LIME-based features for classifying one or more component types based on the plurality of test outputs; and determining, using the one or more LIME-based features, the one or more evaluation metrics. In some embodiments, the operations further comprise determining CRS based on the one or more LIME-based features. In some embodiments, the operations further comprise determining, using the one or more LIME-based features, MPR based on model performance corresponding to a candidate machine learning model of the plurality of candidate machine learning models.

According to some embodiments, one or more non-transitory computer-readable storage media including instructions that, when executed by one or more processors, cause the one or more processors to perform operations comprising generating, using a plurality of candidate machine learning models, a plurality of prediction outputs based on a testing dataset; determining, using the plurality of prediction outputs, a machine learning model from the plurality of candidate machine learning models based on one or more evaluation metrics; generating, using the machine learning model, one or more class activation map (CAM) images for an input image; and generating one or more counterfactual explanations based on the one or more CAM images and a subset of prediction outputs of the plurality of prediction outputs that correspond to the machine learning model.

### BRIEF DESCRIPTION OF THE DRAWINGS

Embodiments incorporating teachings of the present disclosure are shown and described with respect to the figures presented herein.

FIG. 1 provides an example overview of an architecture in accordance with some embodiments of the present disclosure.

FIG. 2 provides an example computing entity in accordance with some embodiments of the present disclosure.

FIG. 3 provides an example client computing entity in accordance with some embodiments of the present disclosure.

FIG. 4 presents a flowchart of an example process for evaluating XAI algorithms according to some embodiments of the present disclosure.

FIG. 5 depicts example visual representations of heatmaps on input images of printed circuit board (PCB) samples in accordance with some embodiments of the present disclosure.

FIG. 6 depicts example visual representations of heatmaps on input images of packaging samples in accordance with some embodiments of the present disclosure.

FIG. 7 depicts example heatmaps generated using GradCAM to visualize representative regions of classifier predictions of a trained machine learning model in accordance with some embodiments of the present disclosure.

FIG. 8 are example counterfactual representations of a via image in accordance with some embodiments of the present disclosure.

FIG. 9 is an example GradCAM heatmap of a classifier prediction for microbump images in accordance with some embodiments of the present disclosure.

FIG. 10 depicts two counterfactual representations of microbumps in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

The present disclosure provides evaluation metrics for explainable artificial intelligence (XAI) techniques, enhancing transparency in semiconductor scenarios.

The quality of high-resolution acoustic imaging of 3D heterogenous integration (HI) devices may depend on factors, such as transducer frequency, aperture, sound velocity, focal length, and the maintenance of constant flight time during scanning. A higher-frequency transducer may enhance resolution but compromises signal-to-noise ratio (SNR) and introduces noise in scanning acoustic microscopy (SAM) images. Time-of-flight (TOF) may also pose challenges in high-resolution imaging of 3D HI interconnections. Surface triggers may help with focus maintenance, yet certain areas may remain prone to defocus, which may demand consistent TOF compensation for artifacts. The application of SAM in interconnection detection also faces challenges in interpreting defects from low-resolution acoustical imaging. Even at higher frequencies, C-mode SAM (C-SAM) resolution may be inadequate for defect localization in advanced packaging. Stacked die complexities of 3D HI devices may further complicate detection, as thinner layers with smaller spacing and shorter ultrasound delay times between interfaces cause failure detection to be challenging and may lead to potential false readings by C-SAM.

Difficulties in imaging semiconductor devices are further exacerbated by the shrinking size of integrated circuit (IC) features and the widespread use of heterogeneous and wafer-level packaging. As semiconductor packages decrease in size to accommodate higher component densities, accurate identification of small attributes, such as microbumps and through-silicon vias (TSVs) may be more difficult. The presence of three-dimensional structures, stacked dies, and various materials may also add complexity and variations that hinder visualization. Additionally, embedded components, such as capacitors and resistors, introduce an additional layer of complexity, which may require specialized techniques for examination. The reliability of critical components, such as TSVs, which may be important for three-dimensional connectivity, may demand careful scrutiny to identify flaws that affect electrical connectivity. Precise alignment may be important, especially when dealing with unusual shapes. Challenges may also arise with advanced packaging materials, such as low-k dielectrics, where the ability to detect defects may be critical. Dynamic imaging techniques may also be used to address potential failures over time, and continuous advancements in imaging technologies may be important for reliable inspection processes in advanced packaging systems.

Current non-destructive 2D and 3D imaging methods struggle to detect sub-micron defects in interconnections smaller than 10 μm in diameter, especially in a timely manner. The larger size of modern high-density packages presents additional challenges for existing 3D X-ray tools, which may not be able to provide enough detail for fault isolation in small-scale interconnections without extensive processing time. 3D X-ray microscopy, used for chip analysis, may face difficulties when inspecting 300 mm wafers during wafer-level bonding or large system-in-package (SiP) end-products. This may be due to practical limitations caused by the need for a sample to be positioned at a certain distance from the source for full rotation, as the inverse square law prevents achieving sub-micron resolution in 3D tomography for a 300 mm wafer with current methods.

The application and development of complex AI models have spurred innovation across many domains. Increases in work efficiency, refined decision-making, and streamlined automation represent key advantages stemming from the application of AI models. However, AI models may produce erroneous output when confronted with input data that deviates from training data used to train such AI models. Such deviations, often not predictable before model deployment, may be realized and adjusted for post-application with model refitting (e.g., fine-tuning) and the inclusion of more diverse samples in training data. Erroneous output may not only undermine trust but precipitate adverse consequences when AI is prematurely deployed. Especially in critical domains, such as medical, military, and financial applications, even small errors in an AI model's decision-making process may yield negative consequences, potentially affecting human lives.

Consequently, research and development of XAI techniques serve to enhance the interpretability of results and provide model transparency to an AI model's decision-making.

XAI algorithms may play a significant role in understanding the complexities of state-of-the-art packaging systems and provide transparency in decision making processes related to such packaging systems. That is, XAI algorithms may be capable of identifying and explaining variations in features, such as microbumps and TSVs, for establishing trust and understanding of the significance of components, such as TSVs in three-dimensional connectivity. XAI metrology may be used to systematically evaluate the clarity of XAI systems with the goal of ensuring comprehensibility and reliability in AI decision making. Traditional XAI evaluation metrics may comprise faithfulness, stability, and/or comprehensibility. Faithfulness may confirm that explanations align with model behavior. Stability may provide consistency across instances. Comprehensibility may be used to assess the clarity of explanations. The aforementioned XAI evaluation metrics may collectively foster transparency and trust in AI systems. Despite the potential advantages of XAI, a lack of standardized assessment measures presents a challenge. That is, a universal metric for all XAI applications is currently lacking. Different contexts may necessitate diverse criteria. Despite the complexity of AI decision-making, there is a noticeable gap in utilizing XAI assessment to enhance comprehensibility in IC advanced packaging or printed circuit board (PCB) inspection.

Various embodiments of the present disclosure provide evaluation measures for evaluating the reliability of XAI techniques in explaining exceptional cases in the physical examination of IC advanced packaging systems. In some embodiments, a framework is provided for evaluating XAI techniques in IC advanced packaging system inspection including metrics that focus on a local interpretable model-agnostic explanations (LIME) method. In some embodiments, the framework comprises (i) model performance retention (MPR) that measures a degree to which XAI features retain model performance and (ii) context relevance score (CRS) that measures how image context influences XAI fidelity. In some embodiments, explanations to PCB and IC advanced packaging images are provided based on X-ray imaging techniques.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Architecture

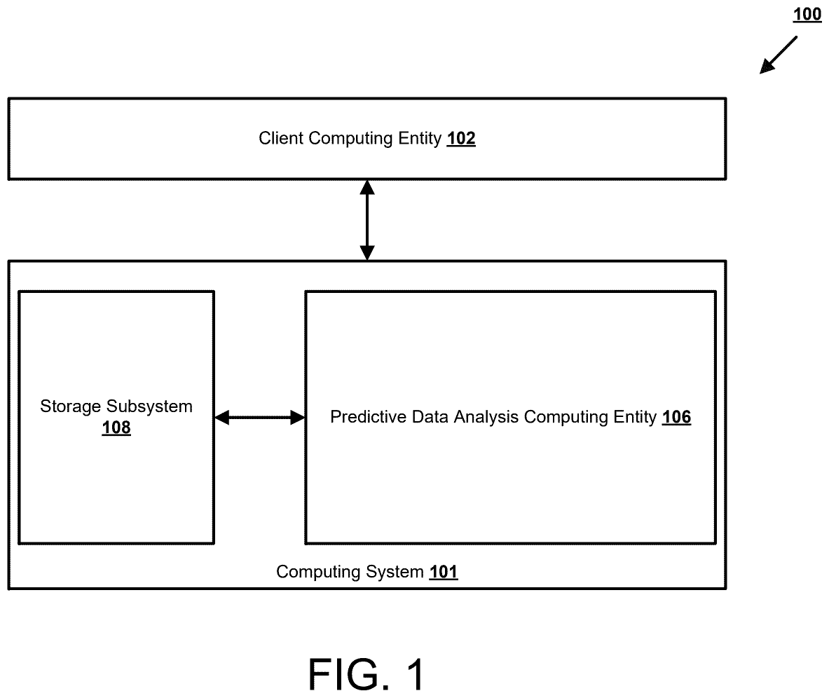

FIG. 1 provides an example overview of an architecture 100 in accordance with some embodiments of the present disclosure. The architecture 100 includes a computing system 101 configured to receive machine learning model (e.g., XAI) analysis requests from client computing entity 102, process the requests to generate analysis results, and provide the analysis results to the client computing entity 102.

In some embodiments, computing system 101 may communicate with at least one of the client computing entity 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive data analysis computing entity 106 and a storage subsystem 108. The predictive data analysis computing entity 106 may be configured to receive machine learning model analysis requests from client computing entity 102, process the requests to generate analysis results, and provide the analysis results to the client computing entity 102.

The storage subsystem 108 may be configured to store input data used by the predictive data analysis computing entity 106 to perform machine learning model analysis. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Example Data Analysis Computing Entity

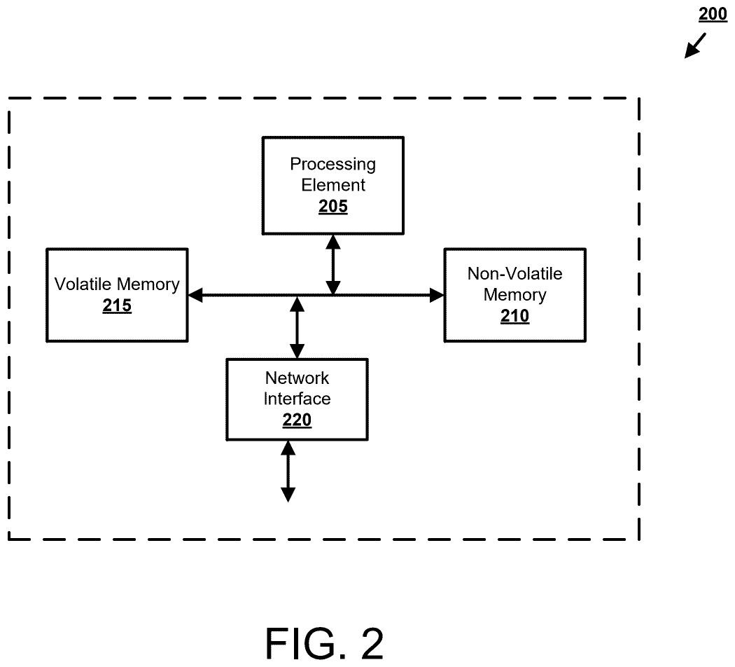

FIG. 2 provides an example computing entity 200 in accordance with some embodiments of the present disclosure. The computing entity 200 is an example of the predictive data analysis computing entity 106. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like.

As shown in FIG. 2, in one embodiment, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing elements 205 may be embodied in a number of different ways.

For example, the processing elements 205 may be embodied as one or more complex programmable logic devices (CPLDs), microprocessors, multi-core processors, coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. Thus, the processing elements 205 may be embodied as ICs, application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In one embodiment, the computing entity 200 may further include, or be in communication with, non-volatile media (also referred to as non-volatile storage, memory, memory storage, memory circuitry, and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the computing entity 200 may further include, or be in communication with, volatile media (also referred to as volatile storage, memory, memory storage, memory circuitry, and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing elements 205. Thus, the databases, database instances, database management systems, data, applications, programs, program modules, scripts, source code, object code, byte code, compiled code, interpreted code, machine code, executable instructions, and/or the like may be used to control certain aspects of the operation of the computing entity 200 with the assistance of the processing elements 205 and operating system.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### Example Client Computing Entity

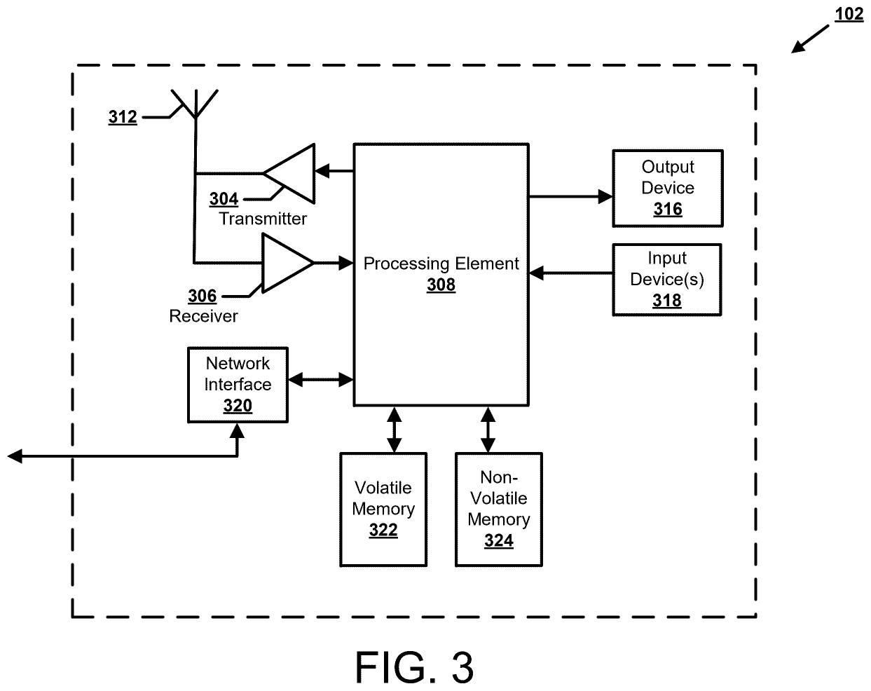

FIG. 3 provides an example client computing entity 102 in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entity 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile storage or memory 322 and/or non-volatile storage or memory 324, which may be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory may store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionality that are the same or similar to those of the computing entity 200, as described in greater detail above. As will be recognized, these architectures and descriptions are provided for exemplary purposes only and are not limited to the various embodiments.

In various embodiments, the client computing entity 102 may be embodied as an artificial intelligence (AI) computing entity. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Example System Operations

Various embodiments of the present disclosure describe steps, operations, processes, methods, functions, and/or the like for improving the assessment of feature-based XAI models that are used in the inspection of IC packaging systems.

LIME may refer to a technique for explaining and providing interpretable insights of prediction outputs generated by black box machine learning models. For example, a black box machine learning model may comprise a machine learning model whose internal workings and decision-making process are not transparent or easily understandable to humans. Implementing LIME may comprise generating a local surrogate model g that approximates the behavior of a black box model f in the vicinity of a specific instance x from an input space. The local surrogate model g may be selected from a simpler and more interpretable class of models, such as a linear regression model. An optimization problem may be associated with the local surrogate model g and may be defined as:

$${min}_{g ∈ G} ℒ ( f , g , {π}_{x} ) + Ω ( g ) \qquad Equation l$$

where L may represent a loss function that measures dissimilarity between the predictions made by the black box model f and the local surrogate model g, calculated over instances sampled based on a proximity distribution πₓ. The term Ω(g) may provide regularization to ensure the simplicity of the local surrogate model g, which may be achieved by perturbing instances around x, sampling according to πₓ, and fitting the local surrogate model g to minimize a defined loss. The resulting local surrogate model g provides a locally faithful and interpretable approximation of the black box model f in the neighborhood of x, which may be used to comprehend the decision-making process of the black box model f.

SHapley Additive explanation (SHAP) may refer to a technique that aims to elucidate the prediction outputs of a machine learning model through the assignment of a value referred to as a Shapley value to data features based on the contribution of the data features to the prediction outputs. For example, given a prediction f(x), SHAP values ϕᵢ may be determined for each data feature xᵢ, representing the marginal contribution of each data feature to the prediction f(x). The SHAP values ϕᵢ may be computed by considering all possible combinations of data features and calculating an average over all permutations. The Shapley value may be defined as:

$${ϕ}_{i} ( f ) = {\sum }_{S ⊆ N ∖ \{ i \}} \frac{\vert S \vert ! ( \vert N \vert - \vert S \vert - 1 ) !}{\vert N \vert !} [ f ( S ⋃ \{ i \} ) - f ( S ) ] \qquad Equation 2$$

where N may denote a set of all data features. Through the consideration of all potential interactions among data features, SHAP values may ensure an equitable distribution of credit among such data features. An overall output (e.g., prediction) of a black box model may be expressed as a summation of the contributions made by individual data features:

$$f ( x ) = {ϕ}_{0} + {\sum }_{i = 1}^{N} {ϕ}_{i} \qquad Equation 3$$

where ϕ₀ may represent an anticipated output generated by the black box model. Accordingly, SHAP values may provide a comprehensive understanding of an extent to which each data feature contributes to a black box model's prediction.

Saliency maps may be used to enhance interpretability in deep learning convolutional neural networks (CNNs) by highlighting key areas in input images that may be crucial for model predictions. For example, saliency maps may reveal which features a CNN prioritizes, aiding in user understanding of a decision-making process of the CNN. Although methods, such as Grad-CAM and Grad-CAM++, may improve interpretability, they have limitations, such as incomplete feature capture and overly sensitive maps that lack contextual information.

According to various embodiments of the present disclosure, Eigen-CAM is employed as a model explainability tool for CNNs. Eigen-CAM may utilize class activation maps (CAM) to discern how models learn from visual data and generate heatmaps superimposed on input images by computing principal components of learned features from convolutional layers. Principal components may vary across convolutional layers, reflecting evolving global representations. Heatmaps across layers or combined may highlight visualization focus that enhance model interpretability while addressing limitations of traditional saliency map methods.

To calculate Eigen-CAM, X may be used to refer to an input image with size (i×j), where X∈ [symbol] _{i,j}, and W_{L=n} may represent a combined weight matrix of first k layers of size (m, n). A class-activated output may comprise a projection of the input image X onto a last convolution layer L=k and may be represented by:

$${O}_{L = k} = {W}_{L = k} X \qquad Equation 4$$

If O_{L=k} is factorized using singular value decomposition to compute the principal components of O_{L=k}, the following may be obtained:

$${O}_{L = k} = U Σ {V}^{T} \qquad Equation 5$$

where U and V may comprise orthogonal matrices, the columns of U may comprise the left singular vectors, Σ may represent a diagonal matrix, and the columns of V may comprise the right singular vectors. The class activation map, L_{Eigen-CAM}, may be given by the projection of O_{L=k} on a first eigenvector:

$${L}_{Eigen - CAM} = {O}_{L = k} {V}_{1} \qquad Equatiom 6$$

where V₁ may represent the first eigenvector in the V matrix.

In some embodiments, in the case of probabilistic learning, a problem may be defined as:
for an input X, score p is returned because variable V has values (υ1, υ2, . . . ) associated with them. If V instead held different values (υ′1, υ′2, . . . ), then score p′ would have returned provided all other variables had remained constant.
   Following the above definition, a counterfactual explanation may be formulated for PCB component classification. Given a model F parameterized by ω that classifies a component image xᵢ to class cᵢ with high probability, a counterfactual x′ may be determined that is as close as possible to an original point (component image xᵢ) and mapped to a new target c′. Counterfactual x′ may be obtained by minimizing the following optimization problem:

$$arg {min}_{{x}^{{}_{′}}} {max}_{λ} ( {λ ( {F}_{w} ( {x}^{{}_{′}} ) - {c}^{{}_{′}} )}^{2} + D ( {x}_{i} , {x}^{{}_{′}} ) ) \qquad Equation 7$$

where D may represent the distance between the original (xᵢ) and the counterfactual (x′) points. Maximization over λ may be executed iteratively until x′ is close enough to xᵢ. A mean absolute deviation (MAD) may be selected over k features as the distance function D.

According to various embodiments of the present disclosure, feature-based XAI models in the context of IC packaging inspection are assessed based on one or more metrics comprising MPR and/or CRS. MPR and CRS may be used to provide an evaluation of XAI algorithms by considering their influence on model performance and a significance of explanations within a particular inspection domain.

MPR may represent a degree in which predictive accuracy is maintained when a XAI algorithm selectively concentrates on a particular set of data features. That is, MPR may represent a measure of an extent in which a machine learning model sustains its overall performance by considering data features associated with XAI explanation. MPR may be defined as:

$$MPR = \frac{Model Performance with XAI Features}{Model Performance with All Features} \times 100 \% \qquad Equation 8$$

In some embodiments, CRS is associated with an evaluation of correspondence between explanations provided by a XAI algorithm and an inherent context of a prediction task. CRS may take into account the significance of features referenced in an explanation within a context (e.g., IC packaging inspection) that is specific to a domain (e.g., semiconductors), recognizing that not all influential features are equally pertinent in a particular prediction scenario. CRS may be defined as:

$$CRS = \frac{{\sum }_{i = 1}^{N} Contextual {Weight}_{i} \times {Importance}_{XAI , i}}{{\sum }_{i = 1}^{N} Contextual {Weight}_{i}} \qquad Equation 9$$

where N may represent a number of features, Contextual Weightᵢ may represent a context relevance weight of feature i, and Importance_{XAI,i} may represent an importance determined via a XAI algorithm. CRS may represent a nuanced understanding of the relevance of features determined using a XAI algorithm in a specific context (e.g., IC packaging inspection) and factors in that certain features may have greater importance within a domain (e.g., semiconductors), contributing to a more contextually informed evaluation of XAI performance.

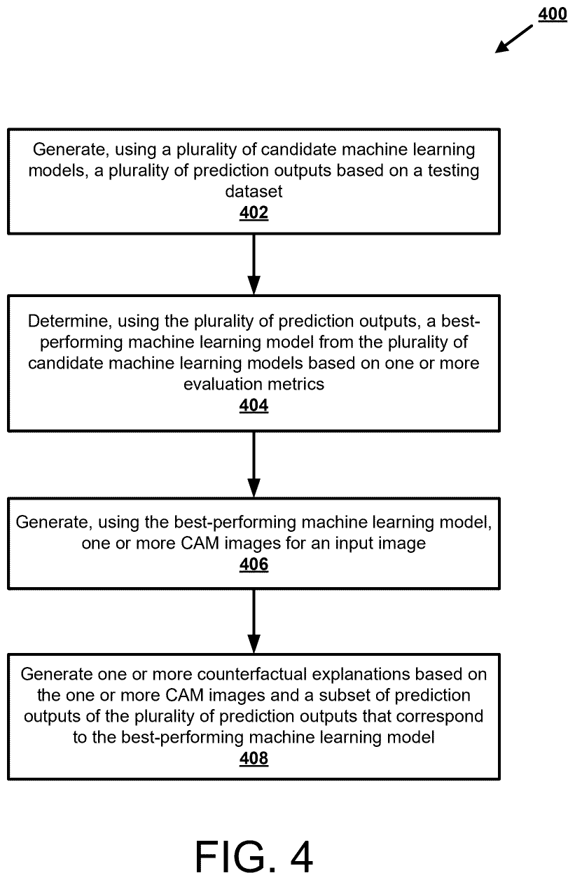

FIG. 4 presents a flowchart of an example process 400 for evaluating XAI algorithms according to some embodiments of the present disclosure.

In some embodiments, the process 400 begins at step/operation 402 when the computing system 101 generates, using a plurality of candidate machine learning models, a plurality of prediction outputs based on a testing dataset. In some example embodiments, the plurality of candidate machine learning models comprises a random forest classifier, a K-nearest neighbor (KNN) classifier, a logistic regression classifier, or a decision tree classifier. The testing dataset may comprise PCB x-ray images and/or IC advanced packaging images that facilitate explanation methods, such as LIME. For example, the testing dataset may comprise perturbed data features associated with a plurality of texture and shape features, as well as relevant metadata, such as file names, component ID, component types or classes, and sample type.

In some embodiments, at step/operation 404, the computing system 101 determines, using the plurality of prediction outputs, a best-performing machine learning model from the plurality of candidate machine learning models based on one or more evaluation metrics. Determining the best-performing machine learning model may comprise determining the ability of the plurality of candidate machine learning models to generate correct predictions of one or more circuit components based on one or more specific features. The performance corresponding to the plurality of candidate machine learning models may be compared with each other to determine a best-performing model that is subsequently evaluated for further investigation based on one or more evaluation metrics.

In some embodiments, the one or more evaluation metrics comprise MPR and/or CRS. The one or more evaluation metrics may be determined based on one or more XAI features. For example, a LIME evaluation may be performed on the plurality of candidate machine learning models to determine one or more LIME-based features that may be important in generating predictions (e.g., predicting a type of PCB and/or IC packaging component). To do so, an explanatory dataset may be generated based on the testing dataset and the plurality of prediction outputs corresponding to the plurality of candidate machine learning models. An interpretable model corresponding to a candidate machine learning model of the plurality of machine learning models may be trained with the explanatory dataset and used to generate a plurality of test outputs.

One or more LIME-based features may be determined based on the plurality of test outputs and used to determine an evaluation metric. For example, CRS may be determined based on one or more LIME-based features and MPR may be determined based on model performance (e.g., accuracy and/or F1-score based on test outputs of a candidate machine learning model) using one or more LIME-based features. The one or more LIME-based features may be determined from a plurality of component features (e.g., circularity, eccentricity, aspect ratio, gray-level co-occurrence matrix (GLCM) contrast, perimeter, solidity, area, entropy, convexity, Tamura contrast, Tamura directionality, and/or Tamura coarseness) that are determined as prominent features for classifying one or more component types (e.g., solder balls, pin grid arrays (PGA), vias, and/or microbumps). Accordingly, the one or more evaluation metrics may provide valuable insights into identifying distinct features that differentiate components with similar structures, which may be particularly important in addressing edge cases in automated physical inspection.

In some embodiments, a SHAP evaluation is performed with the plurality of candidate machine learning models to provide validation of the LIME evaluation. SHAP evaluation may comprise identifying component features that affect the identification of PCB and IC advanced packaging components by the plurality of candidate machine learning models. For example, Tamura texture features, such as Tamura coarseness, Tamura directionality, and Tamura contrast, may comprise crucial factors in differentiating microbumps from other components. Accordingly, the SHAP-based features may be compared with the LIME-based features for validation.

In some embodiments, at step/operation 406, the computing system 101 generates, using the best-performing machine learning model, one or more CAM images for an input image. Generating the one or more CAM images may comprise determining Eigen-CAM for one or more target layers. In some embodiments, generating the one or more CAM images comprises superimposing one or more CAM images (e.g., that are generated by determining Eigen-CAM for the one or more target layers) on the input image. One or more CAM images may visually identify regions of the input image that contribute most significantly to the best-performing machine learning model's predictions at different stages of the best-performing machine learning model's network. For example, generating the one or more CAM images may comprise generating one or more heatmaps from different layers of the best-performing machine learning model to understand in which portion of an input image contributed more at a specific layer of the best-performing machine learning model. In some example embodiments, generating the one or more CAM images comprises overlaying a heatmap on top of the input image, where red areas or spots may indicate higher levels of magnitude. For example, red areas may be placed over places that are visually significant in differentiating specific properties of a component.

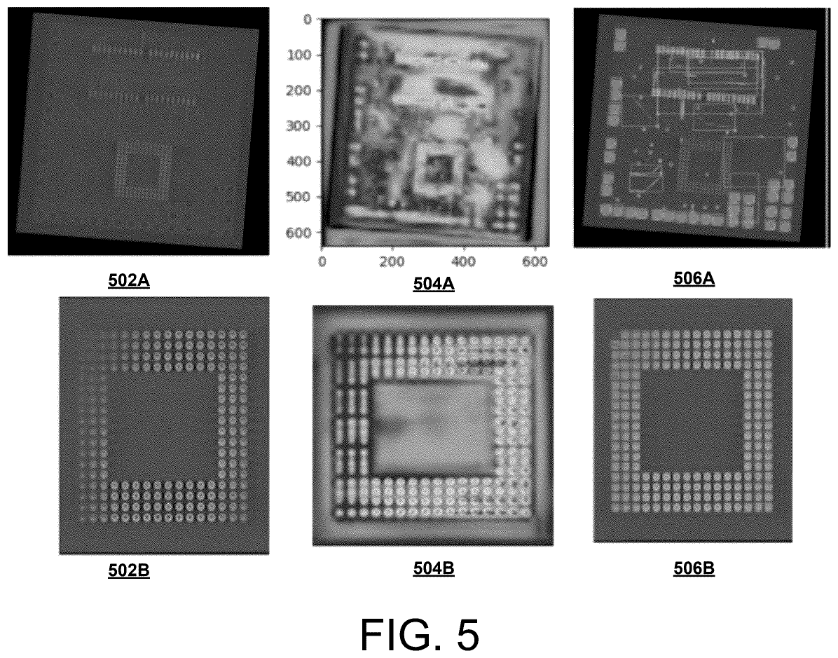

FIG. 5 depicts example visual representations of heatmaps on input images of PCB samples in accordance with some embodiments of the present disclosure. As depicted in FIG. 5, heatmaps 504A and 504B are generated on consecutive layers of a trained machine learning model for input images 502A and 502B of PCBs, respectively. The heatmaps 504A and 504B may comprise yellow and red spots that indicate where the model is focusing to identify solder balls, vias, and some pads in the input image. Prediction results 506A and 506B of the trained machine learning model may be compared with the heatmaps 504A and 504B to demonstrate the trained machine learning model's ability to predict at least some components indicated by the heatmaps 504A and 504B. For example, a region with yellow and red spots on the heatmaps 504A and 504B may indicate that the trained machine learning model assigned greater importance in that region to locate and predict components.

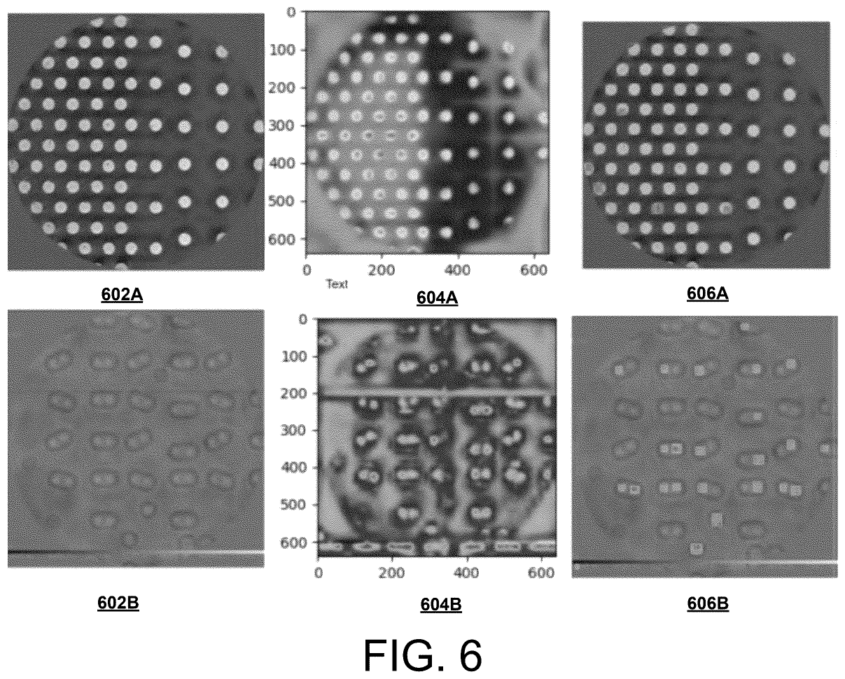

FIG. 6 depicts example visual representations of heatmaps on input images of advanced packaging samples in accordance with some embodiments of the present disclosure.

Heatmaps 604A and 604B are generated on consecutive layers of a trained machine learning model for input images 602A and 602B of advance packaging sample for a microbump class. The heatmaps 604A and 604B comprise dense red spots which may suggest bias in training data towards the microbump class in input images 602A and 602B. The red spots may be confirmed when compared with the model's prediction results 606A and 606B. Heatmap 604B depicting red spots may be indicative of the trained model's erroneous focus on a number value in the input image 602B. However, when compared with the trained model's prediction result 606B comprising a microbump in the leftmost corner which may validate the reason why the model is predicting a number value 8 in the leftmost corner as a microbump.

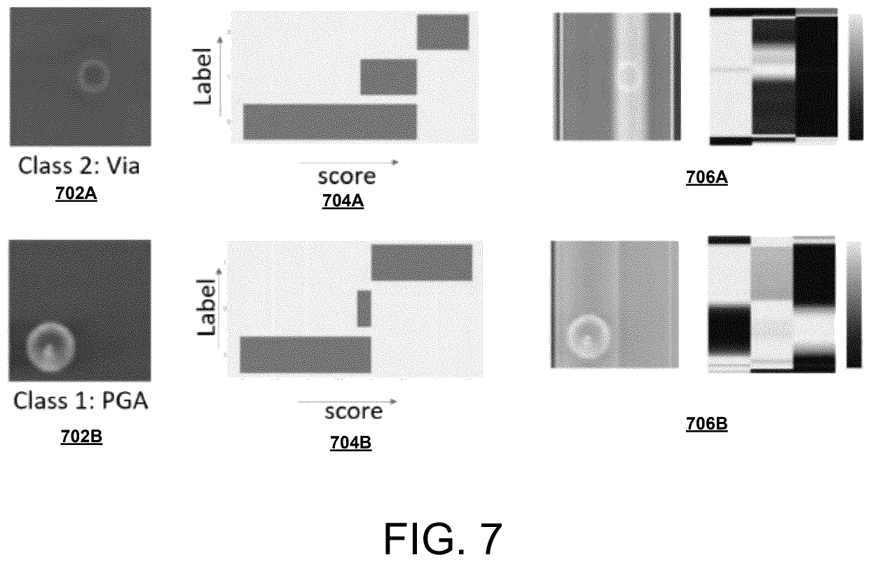

FIG. 7 depicts example heatmaps generated using GradCAM to visualize representative regions of classifier predictions of a trained machine learning model in accordance with some embodiments of the present disclosure. The query image 702A comprises a via that is identified by a circular boundary and the query image 702B comprises a PGA that includes values inside the circular boundary that are activated. Unnormalized prediction values 704A and 704B from the trained machine learning model are provided for the query images 702A and 702B, respectively. Heatmaps 706A and 706B depict regions highlighted by GradCAM that are associated with each particular prediction. In the illustrated example, the GradCAM is generated from a second convolution layer of the trained machine learning model. Different values of the kernel on the layer feature are represented by different colors in a score matrix.

Referring back to FIG. 4, in some embodiments, at step/operation 408, the computing system 101 generates one or more counterfactual explanations based on the one or more CAM images and a subset of prediction outputs of the plurality of prediction outputs that correspond to the best-performing machine learning model. Counterfactual explanations may visually highlight differences for explaining edge cases in advanced IC packaging inspection. That is, a counterfactual representation of a prediction for a particular prediction output may comprise an indication in the one or more CAM images that caused the prediction.

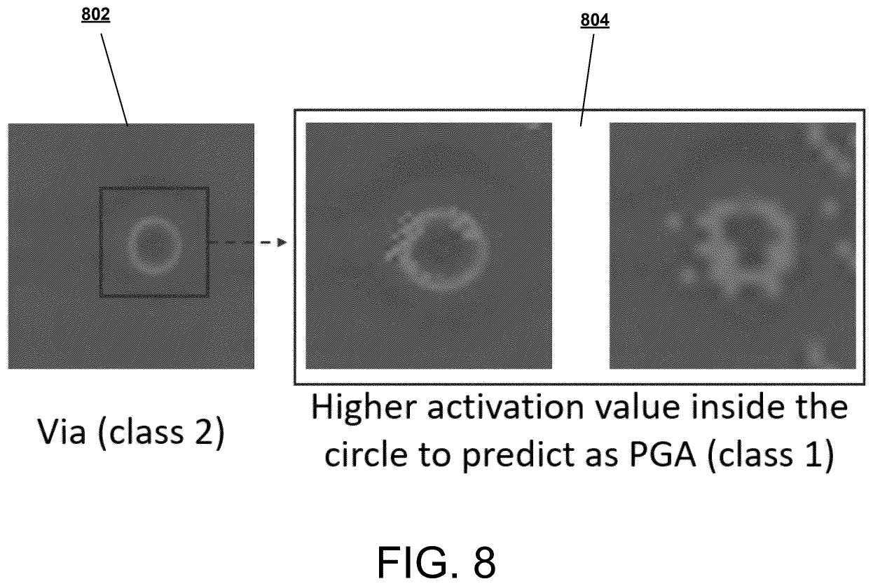

FIG. 8 are example counterfactual representations of a via image in accordance with some embodiments of the present disclosure. As depicted in FIG. 8, the example counterfactual representations may be used to induce a trained machine learning model to predict an input image 802 of a via (class 2) as a PGA (class 1). To generate a counterfactual representation of class via (e.g., to make the model predict a via sample as a PGA) some pixels inside the circular boundary of the input image 802 may be presented as activated 804.

In some embodiments, an OmniXai library may be used to generate the counterfactual representations via a multiple discriminate analysis (MDA) algorithm to find the closest counterfactual representation of the original input image. For example, the MDA algorithm may activate some pixel values inside the circular boundary to fool the model into predicting the input image of the via as a PGA.

In some embodiments, images of microbumps are extracted from X-ray images of advanced IC packaging. A training dataset comprising microbump images and PCB components may be used to train a classifier to learn robust representation.

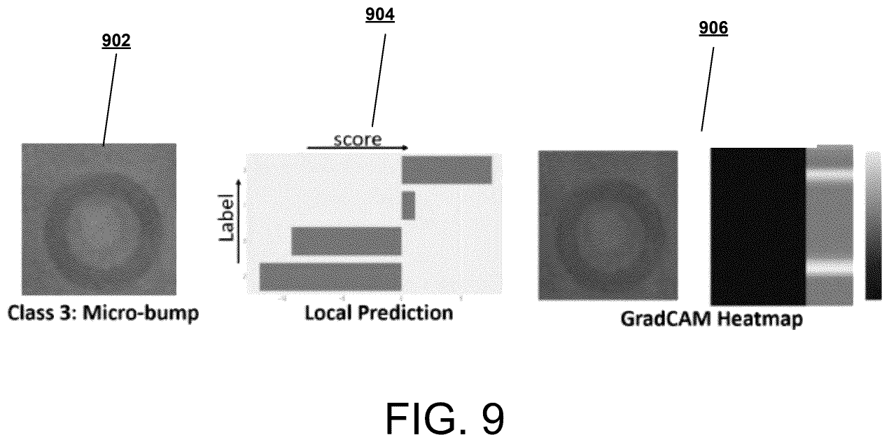

FIG. 9 is an example GradCAM heatmap 906 of a classifier prediction 904 for a microbump image 902 in accordance with some embodiments of the present disclosure. In some embodiments, microbumps that are associated with an input query image may be modified for a trained machine learning model to predict it as PGA.

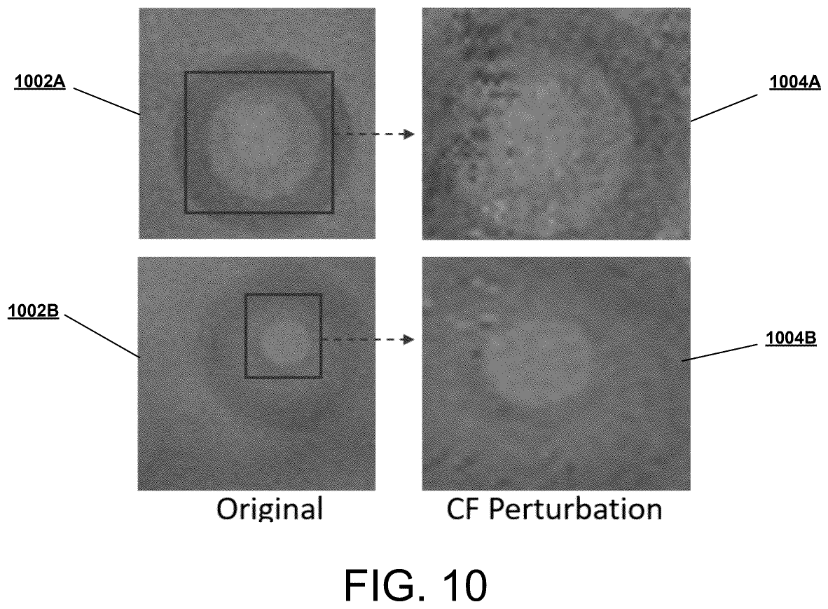

FIG. 10 depicts two counterfactual representations of microbumps in accordance with some embodiments of the present disclosure. The pixels on the microbumps 1002A and 1002B are perturbed to generate counterfactual representations 1004A and 1004B of the microbumps similar to PGA. While generating counterfactual representation, an MDA algorithm may be used to perturb pixels on microbumps to simulate a feature behavior that is associated with a PGA class where few pixels inside the circular boundary are activated and other pixels are not, as depicted in FIG. 10.

### Conclusion

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A computer-implemented method comprising:
generating, by one or more processors and using a plurality of candidate machine learning models, a plurality of prediction outputs based on a testing dataset;
determining, by the one or more processors and using the plurality of prediction outputs, a machine learning model from the plurality of candidate machine learning models based on one or more evaluation metrics;
generating, by the one or more processors and using the machine learning model, one or more class activation map (CAM) images for an input image; and
generating, by the one or more processors, one or more counterfactual explanations based on the one or more CAM images and a subset of prediction outputs of the plurality of prediction outputs that correspond to the machine learning model.

2. The computer-implemented method of claim 1, wherein the testing dataset comprises a plurality of printed circuit board x-ray or integrated circuit packaging images.

3. The computer-implemented method of claim 1, wherein determining the machine learning model comprises determining an ability of the plurality of candidate machine learning models to generate one or more correct predictions corresponding to one or more circuit components.

4. The computer-implemented method of claim 1, wherein the one or more evaluation metrics comprise (i) model performance retention (MPR) that measures a degree to which explainable artificial intelligence (XAI) features retain model performance or (ii) context relevance score (CRS) that measures how image context influences XAI fidelity.

5. The computer-implemented method of claim 1 further comprising performing a local interpretable model-agnostic explanations (LIME) evaluation on the plurality of candidate machine learning models to determine one or more LIME-based features that correspond to generating a prediction output associated with a type of printed circuit board (PCB) or an integrated circuit packaging component.

6. The computer-implemented method of claim 5 further comprising:
generating an explanatory dataset based on the testing dataset and the plurality of prediction outputs;
generating, using an interpretable model trained with the explanatory dataset, a plurality of test outputs;
determining one or more LIME-based features for classifying one or more component types based on the plurality of test outputs; and
determining, using the one or more LIME-based features, the one or more evaluation metrics.

7. The computer-implemented method of claim 6 further comprising determining CRS based on the one or more LIME-based features.

8. The computer-implemented method of claim 6 further comprising determining, using the one or more LIME-based features, MPR based on model performance corresponding to a candidate machine learning model of the plurality of candidate machine learning models.

9. The computer-implemented method of claim 6, wherein determining the one or more LIME-based features comprises determining the one or more LIME-based features from a plurality of component features.

10. The computer-implemented method of claim 9, wherein the plurality of component features comprises one or more of circularity, eccentricity, aspect ratio, gray-level co-occurrence matrix (GLCM) contrast, perimeter, solidity, area, entropy, convexity, Tamura contrast, Tamura directionality, or Tamura coarseness.

11. The computer-implemented method of claim 5 further comprising performing a SHapley Additive explanation (SHAP) evaluation with the plurality of candidate machine learning models to provide validation of the LIME evaluation.

12. The computer-implemented method of claim 1, wherein generating the one or more CAM images comprises:
determining Eigen-CAM for one or more target layers; and
superimposing the one or more CAM images on the input image.

13. The computer-implemented method of claim 1, wherein generating the one or more CAM images further comprises generating one or more heatmaps from different layers of the machine learning model.

14. A system comprising:
one or more processors and
at least one memory storing processor-executable instructions that, when executed by any of the one or more processors, causes the one or more processors to perform operations comprising:
generating, using a plurality of candidate machine learning models, a plurality of prediction outputs based on a testing dataset;
determining, using the plurality of prediction outputs, a machine learning model from the plurality of candidate machine learning models based on one or more evaluation metrics;
generating, using the machine learning model, one or more class activation map (CAM) images for an input image; and
generating one or more counterfactual explanations based on the one or more CAM images and a subset of prediction outputs of the plurality of prediction outputs that correspond to the machine learning model.

15. The system of claim 14, wherein the one or more evaluation metrics comprise (i) model performance retention (MPR) that measures a degree to which explainable artificial intelligence (XAI) features retain model performance or (ii) context relevance score (CRS) that measures how image context influences XAI fidelity.

16. The system of claim 14, wherein the operations further comprise performing a local interpretable model-agnostic explanations (LIME) evaluation on the plurality of candidate machine learning models to determine one or more LIME-based features that correspond to generating a prediction output associated with a type of printed circuit board (PCB) or an integrated circuit packaging component.

17. The system of claim 16, wherein the operations further comprise:
generating an explanatory dataset based on the testing dataset and the plurality of prediction outputs;
generating, using an interpretable model trained with the explanatory dataset, a plurality of test outputs;
determining one or more LIME-based features for classifying one or more component types based on the plurality of test outputs; and
determining, using the one or more LIME-based features, the one or more evaluation metrics.

18. The system of claim 17, wherein the operations further comprise determining CRS based on the one or more LIME-based features.

19. The system of claim 17, wherein the operations further comprise determining, using the one or more LIME-based features, MPR based on model performance corresponding to a candidate machine learning model of the plurality of candidate machine learning models.

20. One or more non-transitory computer-readable storage media including instructions that, when executed by one or more processors, cause the one or more processors to perform operations comprising:
generating, using a plurality of candidate machine learning models, a plurality of prediction outputs based on a testing dataset;
determining, using the plurality of prediction outputs, a machine learning model from the plurality of candidate machine learning models based on one or more evaluation metrics;
generating, using the machine learning model, one or more class activation map (CAM) images for an input image; and
generating one or more counterfactual explanations based on the one or more CAM images and a subset of prediction outputs of the plurality of prediction outputs that correspond to the machine learning model.
